(19) United States
(12) Patent Application Publication
(10) Pub. No.: US 2026/0051177 A1
(43) Pub. Date: Feb. 19, 2026

(54) OBJECT DETECTION DEVICE AND OBJECT DETECTION METHOD

(71) Applicant: Panasonic Automotive Systems Co., Ltd., Kanagawa (JP)

(72) Inventor: Atsushi NOJIRI, Tokyo (JP)

(21) Appl. No.: 18/749,235

(22) Filed: Jun. 20, 2024

(30) Foreign Application Priority Data
Aug. 8, 2023 (JP) 2023-129048

(51) Int. Cl. G06V 20/58; B60W 30/095; G01S 15/08; G06T 7/70; G06V 10/764

(52) U.S. Cl. CPC G06V 20/58; B60W 30/0956; G01S 15/08; G06T 7/70; G06V 10/764; B60W 2554/4029; G06T 2207/10028; G06T 2207/30196; G06T 2207/30256

(57) ABSTRACT

An object detection device includes an estimation circuit, an accumulation circuit, and an extraction circuit. The estimation circuit estimates a first position of an object multiple times by using a first distance to the object and an azimuth of the object. The first distance is measured by one or more range finders. The azimuth is estimated from an image of the object acquired by an imaging sensor. The accumulation circuit accumulates the first positions of the object estimated the multiple times. The first positions are accumulated for each predetermined distance from the imaging sensor. The extraction circuit extracts a second position of the object from the accumulation result.

### CROSS-REFERENCE TO RELATED APPLICATIONS

This application is based upon and claims the benefit of priority from Japanese Patent Application No. 2023-129048, filed Aug. 8, 2023, the entire contents of which are incorporated herein by reference.

### FIELD

The present disclosure relates generally to an object detection device and an object detection method.

### BACKGROUND

An object detection device mounted on a vehicle serves to detect an object around the periphery of the vehicle. A result of the detection by the object detection device is used for driving assist processing performed by the vehicle for avoiding collision with the object.

In the object detection device, an imaging sensor that acquires an image of an object may be used in conjunction with a range finder that measures a distance to the object.

There is a case where the range finder has difficulty in performing the ranging by a reflected wave. In such a case, sensitivity adjustment is performed (See, for example, patent literature WO 2018/079252).

However, even though the sensitivity adjustment described above is performed, accuracy of the ranging may still be insufficient.

### SUMMARY

An object detection device according to the present disclosure includes an estimation circuit, an accumulation circuit, and an extraction circuit. The estimation circuit is which, in operation, estimates a first position of an object multiple times by using a first distance to the object and an azimuth of the object. The first distance is measured by one or more range finders. The azimuth is estimated from an image of the object acquired by an imaging sensor. The accumulation circuit is which, in operation, accumulates the first positions of the object estimated the multiple times. The first positions are accumulated for each predetermined distance from the imaging sensor. The extraction circuit is which, in operation, extracts a second position of the object from the accumulation result.

### BRIEF DESCRIPTION OF THE DRAWINGS

FIG. 1 is a side view illustrating a schematic configuration of a vehicle in which an object detection device according to an embodiment is mounted;

FIG. 2 is a plan view illustrating the schematic configuration of the vehicle in which the object detection device according to the embodiment is mounted;

FIG. 3 is a block diagram illustrating a hardware configuration of the vehicle in which the object detection device according to the embodiment is mounted;

FIG. 4 is a block diagram illustrating a functional configuration of the vehicle in which the object detection device according to the embodiment is mounted;

FIG. 5 is a diagram illustrating an estimated azimuth in the embodiment;

FIG. 6 is a diagram illustrating setting of regions on a straight line in the embodiment;

FIG. 7 is a diagram illustrating a distribution of reflection intensity on the straight line in the embodiment;

FIGS. 8A and 8B are each a diagram illustrating a difference in reflection feature between an object and a road surface in the embodiment;

FIGS. 9A to 9C are each a diagram illustrating reflection points of the object and the road surface in the embodiment;

FIG. 10 is a diagram illustrating a distribution of cumulative reflection intensity on the straight line in the embodiment; and

FIG. 11 is a flowchart illustrating an operation of the object detection device according to the embodiment.

### DETAILED DESCRIPTION

Hereinafter, an embodiment of an object detection device according to the present disclosure will be described with reference to the drawings.

### Embodiment

An object detection device according to an embodiment is mounted on a vehicle to detect an object around the periphery of the vehicle. A detection result is used for driving assist processing in the vehicle such as avoidance of collision with the object. For such an object detection device, improvements are made to obtain a highly accurate position of a detection target object.

For example, in an object detection device of the existing technology, while an object having a larger reflection surface has a larger (stronger) reflection intensity and can be detected up to a distant place by a range finder, an object having a smaller reflection surface has a smaller (weaker) reflection intensity. Therefore, it may be difficult to accurately detect an object in some cases of a distance between the object and the range finder. Therefore, the object detection device performs sensitivity adjustment by lowering a reflection threshold value of the range finder so that an object having a small reflection intensity can be detected, and thereby secures a detection range. However, due to the lowering of the threshold value, the range finder also detects a non-detection target object such as a road surface.

Considering the problem above, in the existing technology (for example, WO 2018/079252 A, described above), a method of lowering a threshold value in the vicinity of a distance of an object detected by an imaging sensor is adopted. However, in a case where sensitivity adjustment cannot be performed within a correct range by using a detection result due to influence of the type of the imaging sensor and/or the background of the detection target, the non-detection target object is erroneously detected. For this reason, in some cases, the object detection device of the existing technology may detect and determine the detection target object at an inaccurate position. In contrast, according to the present disclosure, a threshold value of an entire detection area is set to be low, and a non-detection target object such as the road surface and a detection target object are distinguished from each other. With this configuration, accuracy of position detection can be improved even for a detection target object having a small reflection intensity.

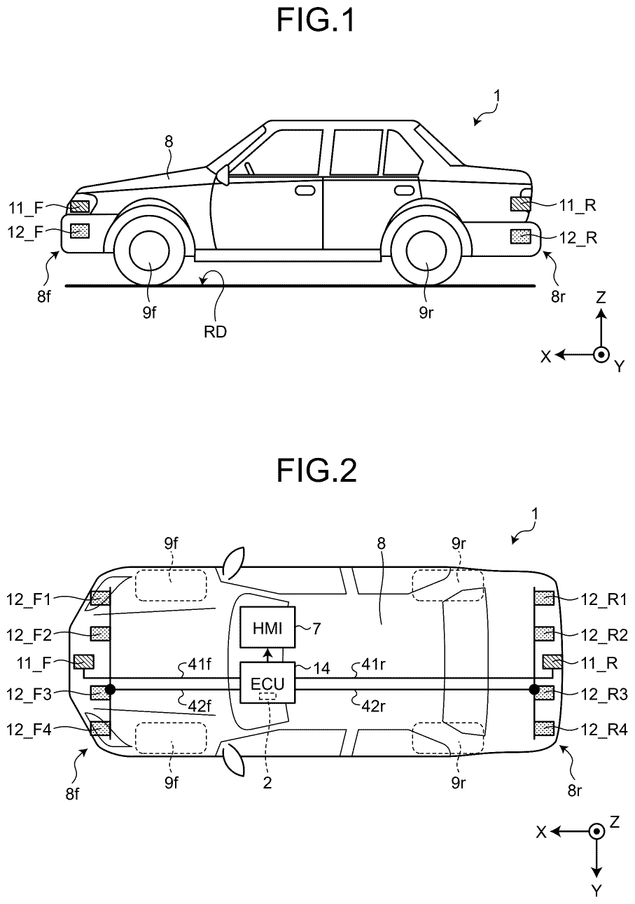

An object detection device 2 can be mounted on a vehicle 1, as illustrated in FIGS. 1 and 2. Hereinafter, a traveling direction of the vehicle 1 is defined as a positive direction of an X-axis, a direction from the right side surface to the left side surface of a vehicle width is defined as a positive direction of a Y-axis, a direction orthogonal to an X-direction and a Y-direction is defined as a Z-direction, and a roof direction of the vehicle 1 is defined as a positive direction of a Z-axis.

The vehicle 1 includes a vehicle body 8, wheels 9f and 9r, imaging sensors 11_F and 11_R, range finders 12_F (12_F1 to 12_F4) and 12_R (12_R1 to 12_R4), an electronic control unit (ECU) 14, and a human-machine interface (HMI) 7.

The wheels 9f and 9r are attached to the vehicle body 8 in an X-axis direction. The front wheels 9f are attached to a front part of the vehicle body 8, and the rear wheels 9r are attached to a rear part of the vehicle body 8. It is noted that, in the X-axis direction, a +X-direction is also referred to as the front, and an −X-direction is also referred to as the rear.

The vehicle body 8 has a substantially rectangular shape in XY plan view. The vehicle body 8 includes, in the X-axis direction, a front end part 8f near a front bumper of a front part and a rear end part 8r near a rear bumper of a rear part.

The imaging sensor 11_F and the range finders 12_F1 to 12_F4 are attached to the front end part 8f. The imaging sensor 11_F is disposed near the center of the vehicle width at the front end part 8f. The range finders 12_F1 to 12_F4 are arranged in the Y-axis direction at the front end part 8f. The respective range finders 12_F1 to 12_F4 are separated from each other in the Y-axis direction and are separated from the imaging sensor 11_F substantially in the Y-axis direction. It is noted that the imaging sensor 11_F and the range finders 12_F1 to 12_F4 may not be arranged at the same position in the X-axis.

FIGS. 1 and 2 illustrate a configuration in which four range finders 12_F1 to 12_F4 are arranged at the front end part 8f, but the number of range finders 12 at the front end part 8f may be three or less, or may be five or more, and is desirably arranged line-symmetrically with respect to the X-axis passing through the center of the vehicle width.

The imaging sensor 11_F is connected to the ECU 14 via a communication line 41f. As the imaging sensor 11_F, any sensor capable of acquiring an image can be used. The imaging sensor 11_F may be, for example, a CMOS image sensor or a CCD image sensor. The imaging sensor 11_F can acquire an image around the periphery of the vehicle body 8, and can supply image data corresponding to the acquired image to the ECU 14.

Each of the range finders 12_F1 to 12_F4 is connected to the ECU 14 via a communication line 42f. Any sensors each capable of measuring a distance can be used as the range finders 12_F1 to 12_F4. Each of the range finders 12_F1 to 12_F4 may be sonar (ultrasonic sensor), a radar, or a LiDAR. The range finders 12_F1 to 12_F4 can acquire a signal indicating a distance to an object around the periphery of the vehicle body 8.

The range finders 12_F1 to 12_F4 each transmit a transmission wave at predetermined intervals, and each receive a reflected wave at a timing different from the transmission timing. The range finders 12_F1 to 12_F4 may each generate a signal indicating a distance L to an object on the basis of a speed v of a measurement medium (for example, a sound wave in the case of sonar, a radio wave in the case of radar, and a laser beam in the case of LiDAR) and a time of flight T from a transmission timing to a reception timing.

Each of the range finders 12_F1 to 12_F4 may be configured such that the transmission timing and the reception timing are alternately switched. In one example, the following operation may be periodically repeated: transmitting a wave by the range finder 12_F1, receiving a wave by the range finder 12_F4, transmitting a wave by the range finder 12_F2, receiving a wave by the range finder 12_F1, transmitting a wave by the range finder 12_F3, receiving a wave by the range finder 12_F2, transmitting a wave by the range finder 12_F4, receiving a wave by the range finder 12_F3, transmitting a wave by the range finder 12_F1, and receiving a wave by the range finder 12_F4.

The range finders 12_F1 to 12_F4 are capable of supplying the acquired signal to the ECU 14.

The ECU 14 is connected to the HMI 7. The ECU 14 includes the object detection device 2. The ECU 14 is capable of detecting an object near the front of the vehicle body 8 by using the object detection device 2 on the basis of the image acquired by the imaging sensor 11_F and the distance measured by the range finders 12_F1 to 12_F4. The ECU 14 can control the vehicle 1 on the basis of a detection result of the object detection device 2 and execute driving assist processing such as collision avoidance with the object.

The imaging sensor 11_R and the range finders 12_R1 to 12_R4 are attached to the rear end part 8r. The imaging sensor 11_R is disposed near the center of the vehicle width at the rear end part 8r. The range finders 12_R1 to 12_R4 are arranged in the Y-axis direction at the rear end part 8r. The range finders 12_R1 to 12_R4 are separated from each other in the Y-axis direction, and are separated from the imaging sensor 11_R substantially in the Y-axis direction. It is noted that the imaging sensor 11_R and the range finders 12_R1 to 12_R4 may not be arranged at the same position on the X-axis.

FIGS. 1 and 2 illustrate a configuration in which four range finders 12_R1 to 12_R4 are arranged at the rear end part 8r, whereas the number of range finders 12 arranged at the rear end part 8r may be three or less, or may be five or more. It is desirable that the range finders 12 be arranged line-symmetrically with respect to the X-axis passing through the center of the vehicle width.

The imaging sensor 11_R is connected to the ECU 14 via a communication line 41r. Any sensor that is capable of acquiring an image can be used as the imaging sensor 11_R. In one example, the imaging sensor 11_R may be a CMOS image sensor or a CCD image sensor. The imaging sensor 11_R can acquire an image around the periphery of the vehicle body 8, and can supply image data corresponding to the acquired image to the ECU 14.

The range finders 12_R1 to 12_R4 are each connected to the ECU 14 via a communication line 42r. Any sensors each capable of measuring a distance can be used as the range finders 12_R1 to 12_R4. Each of the range finders 12_R1 to 12_R4 may be sonar, a radar, or a LiDAR. The range finders 12_R1 to 12_R4 can acquire a signal indicating a distance to an object around the periphery of the vehicle body 8.

The range finders 12_R1 to 12_R4 may each generate a signal indicating a distance L to an object on the basis of a speed v of a measurement medium (for example, a sound wave in the case of sonar, a radio wave in the case of radar, and a laser beam in the case of LiDAR) and a time of flight T from a transmission timing to a reception timing.

Each of the range finders 12_R1 to 12_R4 may be configured such that the transmission timing and the reception timing are alternately switched. In one example, the following operation may be periodically repeated: transmitting a wave by the range finder 12_R1, receiving a wave by the range finder 12_R4, transmitting a wave by the range finder 12_R2, receiving a wave by the range finder 12_R1, transmitting a wave by the range finder 12_R3, receiving a wave by the range finder 12_R2, transmitting a wave by the range finder 12_R4, receiving a wave by the range finder 12_R3, transmitting a wave by the range finder 12_R1, and receiving a wave by the range finder 12_R4.

The range finders 12_R1 to 12_R4 are each capable of supplying the acquired signal to the ECU 14.

The ECU 14 includes the object detection device 2. The ECU 14 can detect, by using the object detection device 2, an object near the rear of the vehicle body 8 on the basis of the image acquired by the imaging sensor 11_R and the distance measured by the range finders 12_R1 to 12_R4. The ECU 14 can control the vehicle 1 according to a detection result of the object detection device 2 and execute predetermined driving assist processing.

In the following description, for the sake of simplicity, the imaging sensor 11_R and the range finders 12_R1 to 12_R4 attached to the rear end part 8r will be mainly described. The imaging sensor 11_R, the range finders 12_R1 to 12_R4, and the communication lines 41r and 42r are simply referred to as the imaging sensor 11, the range finders 12_1 to 12_4, and communication lines 41 and 42, respectively. The following description is similarly applied to the imaging sensors 11_F and the range finders 12_F1 to 12_F4, each being attached to the front end part 8f.

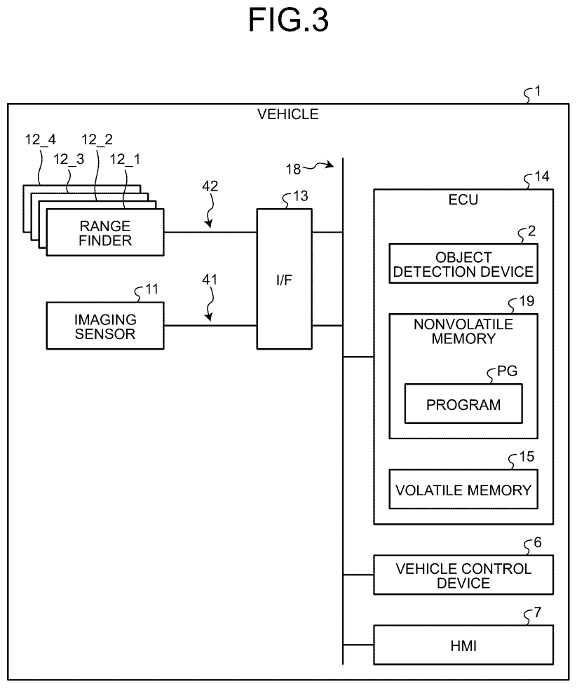

Next, a hardware configuration of the vehicle 1 will be described with reference to FIG. 3.

The vehicle 1 includes an interface (I/F) 13, a vehicle control device 6, and a bus 18 in addition to the configuration illustrated in FIG. 1. The interface 13, the ECU 14, the HMI 7, and the vehicle control device 6 are communicably connected to each other via the bus 18. The ECU 14 includes a volatile memory 15 and a nonvolatile memory 19 in addition to the object detection device 2.

The interface 13 is connected to the imaging sensor 11 via the communication line 41, and is connected to the range finders 12_1 to 12_4 via the communication line 42.

Any device capable of temporarily storing information can be used as the volatile memory 15. In one example, the volatile memory is a dynamic random access memory (DRAM). A device or a system capable of storing information in a nonvolatile manner is used as the nonvolatile memory 19. In one example, the nonvolatile memory 19 is a flash memory or a hard disk. The nonvolatile memory 19 may store a computer program PG used for the driving assist processing.

The ECU 14 controls the vehicle control device 6 to stop the vehicle 1 or causes the HMI 7 to notify warning information corresponding to presence of an object in response to detecting, by the object detection device 2, the object in the vicinity of the rear of the vehicle body 8 (the negative direction of the X-axis).

The vehicle control device 6 drives and controls the wheels 9f and 9r. The vehicle control device 6 can rotate the wheels 9f and 9r, stop the rotation of the wheels 9f and 9r, and steer the wheels 9f and 9r. Although not illustrated, the vehicle control device 6 may include, for example, a vehicle speed sensor, an accelerator sensor, a brake sensor, a brake actuator, an engine controller (or a motor controller), and other devices.

The vehicle control device 6 may control the vehicle 1 to avoid an object detected by the object detection device 2 by controlling a brake actuator and/or an engine controller (or a motor controller) in response to a control signal from the ECU 14.

The HMI 7 may make notification of information indicating a warning by visual means and/or audio means in response to the control signal of the ECU 14. The HMI 7 may generate a display object representing a warning and display the display object on a screen in the vehicle interior, and/or may generate a sound signal of a warning sound or a warning message and output the sound signal from a speaker in the vehicle interior.

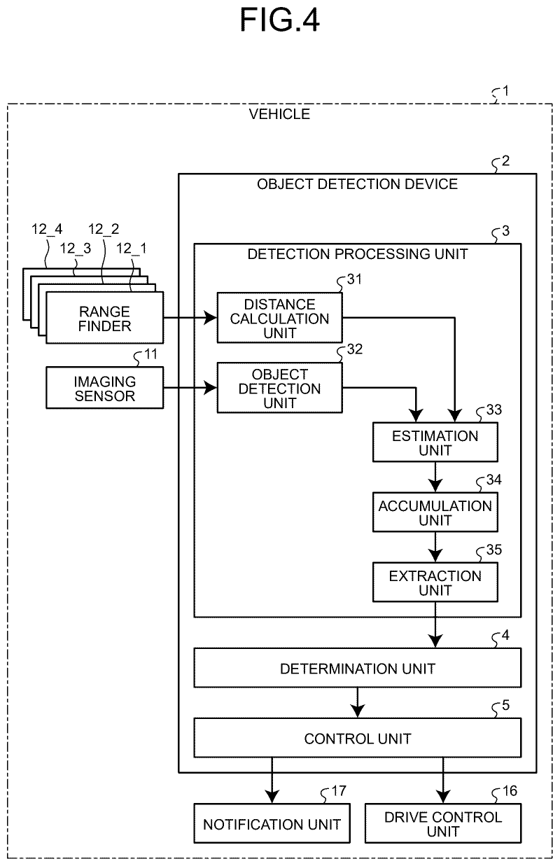

Next, a functional configuration of the vehicle 1 will be described with reference to FIG. 4.

The vehicle 1 includes the imaging sensor 11, the range finders 12_1 to 12_4, the object detection device 2, a drive control unit 16, and a notification unit 17.

The drive control unit 16 can be implemented by the vehicle control device 6 (FIG. 3). The notification unit 17 can be implemented by the HMI 7 (FIG. 3).

The object detection device 2 has multiple functions. All those functions of the object detection device 2 may be implemented by hardware (for example, as circuitry) in the ECU 14. All the functions of the object detection device 2 may be implemented by software in the ECU 14. Part of the functions of in the object detection device 2 may be implemented by hardware, and the remaining part of the functions may be implemented by software. The function implemented by software may be developed as functional modules in the volatile memory 15 collectively at the time of compilation or sequentially in accordance with the progress of processing by allowing the ECU 14 to execute the program PG. With this configuration, it can be equivalently considered that the function is implemented by software in the ECU 14.

As illustrated in FIG. 4, the object detection device 2 may include a detection processing unit 3, a determination unit 4, and a control unit 5.

The detection processing unit 3 is provided between the imaging sensor 11, the range finders 12_1 to 12_4, and the determination unit 4. The determination unit 4 is provided between the detection processing unit 3 and the control unit 5. The control unit 5 is provided between the determination unit 4, and the drive control unit 16 and the notification unit 17.

The detection processing unit 3 virtually creates a coordinate space on a road surface RD around the periphery of the vehicle body 8. The detection processing unit 3 may create the coordinate space with the position of the imaging sensor 11 as an origin. In the information obtained from the image acquired by the imaging sensor 11, accuracy of an azimuth of a subject is relatively high, whereas accuracy of a distance to the subject is relatively low. In the information obtained from the signal of the range finders 12_1 to 12_4, accuracy of an azimuth of a measurement target is relatively low, whereas accuracy of a distance to the measurement target is relatively high. The detection processing unit 3 uses a combination of the image acquired by the imaging sensor 11 and the signal of the range finders 12_1 to 12_4. The detection processing unit 3 detects presence or absence of an object in the coordinate space on the road surface RD and a coordinate position of the object on the basis of the image acquired by the imaging sensor 11 and the distance measured by the range finders 12_1 to 12_4.

In one example, the detection processing unit 3 includes a distance calculation unit 31, an object detection unit 32 (an example of an object detection circuit), an estimation unit 33 (an example of an estimation circuit), an accumulation unit 34 (an example of an accumulation circuit), and an extraction unit 35 (an example of an extraction circuit). The distance calculation unit 31 is provided between the range finders 12_1 to 12_4 and the estimation unit 33. The object detection unit 32 is provided between the imaging sensor 11 and the estimation unit 33. The estimation unit 33 is provided between the distance calculation unit 31 and the object detection unit 32, and the accumulation unit 34. The accumulation unit 34 is provided between the estimation unit 33 and the extraction unit 35.

The distance calculation unit 31 receives a signal from the range finders 12_1 to 12_4. The distance calculation unit 31 extracts a reflection intensity and a distance from the received signal, and generates ranging information in which the reflection intensity and the distance (Ds) are correlated with each other. The distance calculation unit 31 supplies the ranging information to the estimation unit 33.

The object detection unit 32 receives an image acquired by the imaging sensor 11. The object detection unit 32 detects an object included in the image by performing feature extraction on the image and performing comparison processing with a feature learned in advance on a feature extraction result. The object detection unit 32 may determine pixel positions of the object in the image. A detection result obtained by the object detection unit 32 includes the pixel positions of the object and a type of the object in the image. The type of the object includes, for example, a pedestrian, a bicycle, etc. The object detection unit 32 supplies the detection result to the estimation unit 33.

The object detection unit 32 may supply the detection result to the distance calculation unit 31. In a case where the detection result represents that a pedestrian, a bicycle, or the like is present, the distance calculation unit 31 supplied with the detection result may lower a threshold value of the reflection intensity and extract the reflection intensity and the distance from the received signal. In a case where the detection result represents that a pedestrian, a bicycle, or the like is not present, the distance calculation unit 31 may extract the reflection intensity and the distance from the received signal without lowering the threshold value of the reflection intensity. Therefore, load of the extraction processing in the distance calculation unit 31 can be reduced in accordance with the detection result.

The estimation unit 33 receives the ranging information from the distance calculation unit 31, and receives the detection result from the object detection unit 32. The estimation unit 33 estimates an azimuth θc of the object by using the image acquired by the imaging sensor 11. The estimation unit 33 extracts information about the pixel position of the object in the image from the detection result of the object detection unit 32. The estimation unit 33 may estimate the azimuth θc of the object while omitting a camera detection distance Dc depending on the pixel position of the object in the image. The estimation unit 33 may estimate the position of the object (the azimuth θc and the camera detection distance Dc) by using the image.

In one example, the estimation unit 33 calculates the position of the object on the basis of the road surface estimated from a mounting height and a mounting angle of the imaging sensor 11 (camera), a lens feature, etc., and the position at which the object detected by the object detection unit 32 contacts the road surface.

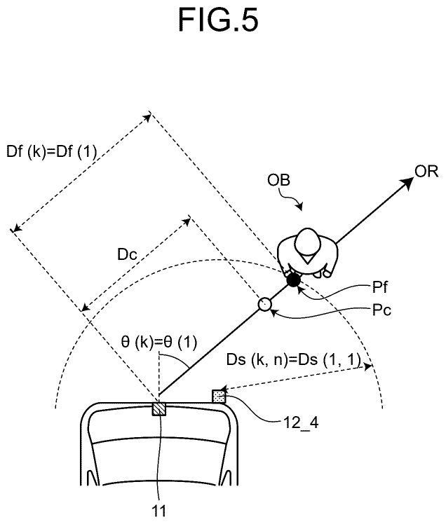

The estimation unit 33 calculates the object azimuth θc and the camera detection distance Dc based on the imaging sensor 11. The object azimuth θc and the camera detection distance Dc are calculated from the position Pc of the object OB that is detected from the image illustrated in FIG. 5. It is noted that the estimation unit 33 may not calculate the camera detection distance Dc with the object OB detected from the image. The estimation unit 33 calculates a fusion distance Df on the azimuth θc of the object OB obtained from the image. The fusion distance Df is calculated by using, as a reflected distance from the object OB, a sonar detection distance Ds measured by the distance calculation unit 31. The estimation unit 33 supplies a result of the estimation to the accumulation unit 34. The estimation result includes information about the azimuth of the object OB and information about the distance of the object OB. It is noted that the measurement by the imaging sensor 11 and the range finder 12 may be periodically repeated. The range finder 12 may measure a plurality of sonar detection distances Ds by one measurement. In one example, when the measurement is repeated k times (k is an integer of one or more) and n distances are detected by each measurement, the number of pieces of information (θc (k)) about the azimuth of the object OB and the number of pieces of information about the fusion distance Df (k) and the sonar detection distance (Ds (k, n)) of the object OB, which are the estimation results to be supplied to the accumulation unit 34, are k and k×n, respectively. It is noted that, for the sonar detection distance Ds (k, n), a value of n may be different for each measurement, and k and n may be different distances. It is noted that FIG. 5 illustrates a case where the range finder 12_4 detects one sonar detection distance Ds (1, 1) by one measurement.

The accumulation unit 34 receives the estimation result from the estimation unit 33. The accumulation unit 34 sets coordinate regions on the road surface RD on the basis of a combination of the image acquired by the imaging sensor 11 and the distance measured by the range finders 12_1 to 12_4. The accumulation unit 34 may set the coordinate regions on a straight line OR corresponding to the azimuth estimated by the estimation unit 33. The accumulation unit 34 may set each of the coordinate regions on a straight line with a width corresponding to the object.

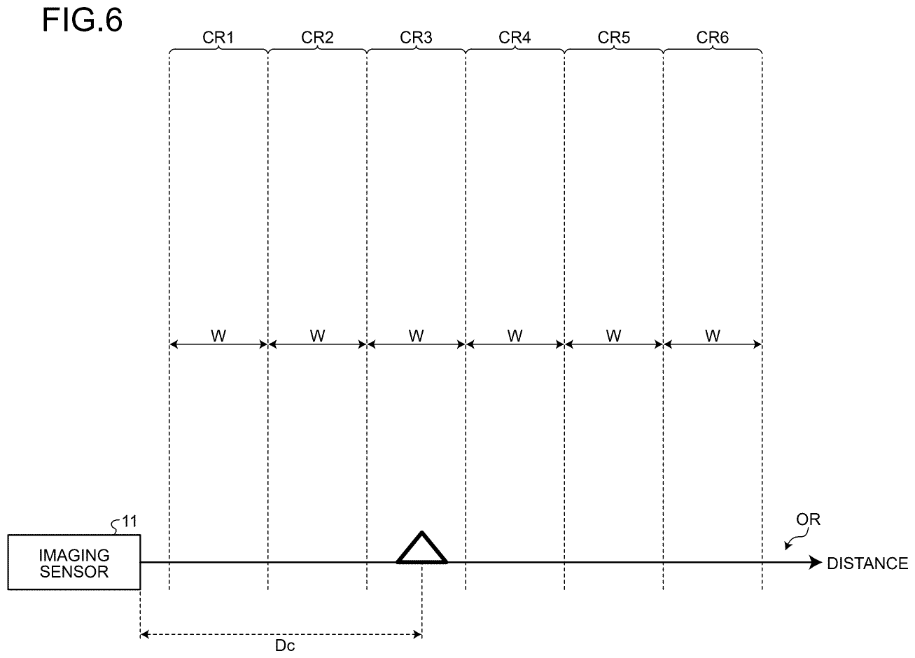

The accumulation unit 34 looks up information about the type of the object included in the detection result by the object detection unit 32, and specifies (determines) the width corresponding to the type of the object. If the object is a pedestrian, a width W that is expected as a pedestrian is determined. It is noted that, as illustrated in FIG. 6, the accumulation unit 34 may set a coordinate region CR3 having the width W including a position corresponding to the distance Dc from the imaging sensor 11 on the straight line OR (see FIG. 5) corresponding to the azimuth. The accumulation unit 34 may sequentially set coordinate regions CR2 and CR1 in units of the width W toward the imaging sensor 11 with respect to the coordinate region CR3, and sequentially set coordinate regions CR4, CR5, and CR6 in units of the width W away from the imaging sensor 11. Moreover, the accumulation unit 34 may set the coordinate region of the width W so as to match with a distribution status of the fusion distance Df.

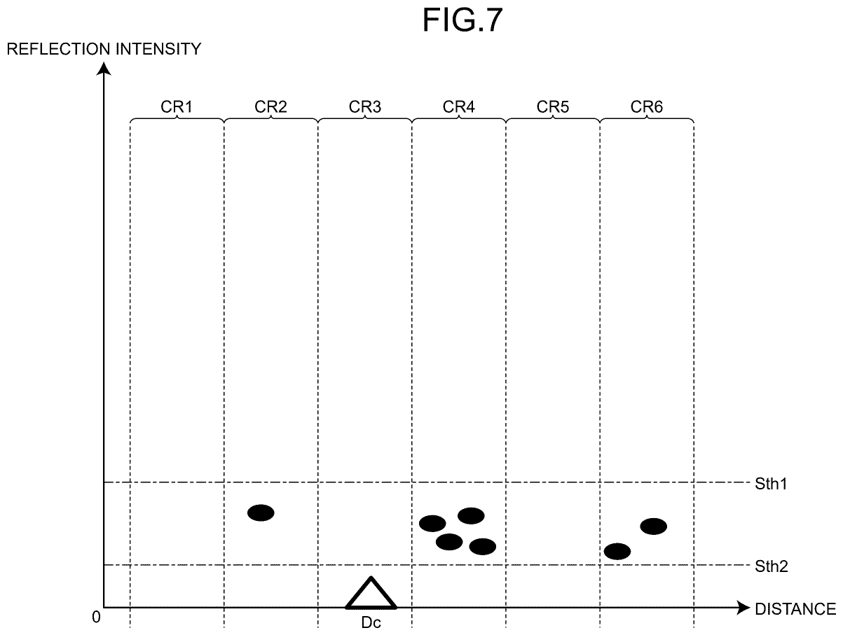

For example, when the reflection intensity is plotted on the vertical axis and the distance from the imaging sensor 11 on the straight line OR is plotted on the horizontal axis, a distribution of the reflection intensity illustrated in FIG. 7 is obtained by plotting values of the reflection intensity indicated by the signal of the range finder 12 used for calculating the fusion distance Df. In FIG. 7, a position corresponding to the distance Dc to the object OB specified from the image of the imaging sensor 11 is indicated by a triangle. In the distribution of the reflection intensity illustrated in FIG. 7, the reflection intensity from the object OB and the reflection intensity from the road surface RD are mixed, and the magnitudes of the reflection intensities are similar to each other. Therefore, in the state of FIG. 7, it is difficult for the object detection device to determine the object OB based on the reflection intensity.

The accumulation unit 34 can set a threshold value Sth1 at a level slightly larger than an average magnitude of the reflection intensity from the road surface RD. Accordingly, with respect to an object having a relatively high reflection intensity such as a wall, the accumulation unit 34 can distinguish a reflection intensity (not illustrated) exceeding the threshold value Sth1 out of the reflection intensities, from the reflection intensity of the road surface RD as the reflection intensity of the object.

However, as illustrated in FIG. 7, a relatively smaller reflection intensity of an object such as a pedestrian may sink under the threshold value Sth1. Additionally, the reflection intensity of the road surface RD mingles with them. Therefore, it is difficult for the accumulation unit 34 to distinguish the reflection intensity of the object from the reflection intensity of the road surface RD.

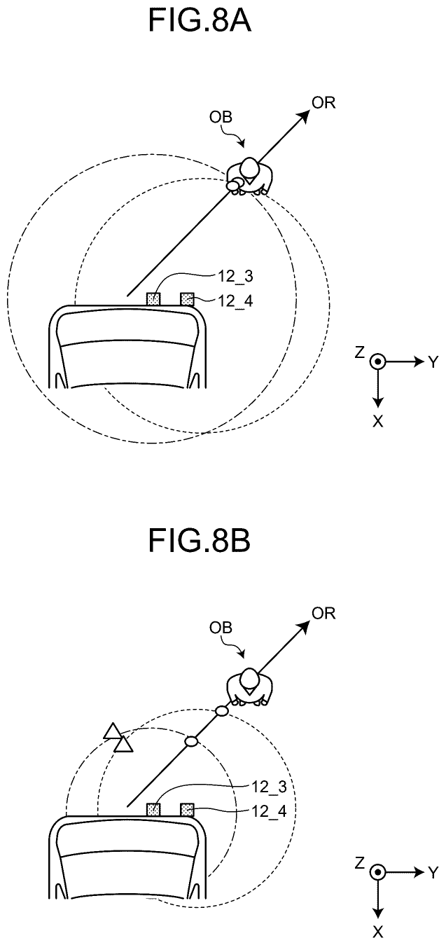

In FIG. 8A and FIG. 8B, for the pedestrian, the specified azimuth θc is indicated by a solid straight line OR as information obtained from the image acquired by the imaging sensor 11.

As information obtained from the signals of the range finders 12_1 to 12_4, in FIG. 8A and FIG. 8B, a distance measured by the range finder 12_3 to the pedestrian is indicated by a dashed-dotted circle, and a distance measured by the range finder 12_4 to the pedestrian is indicated by a dotted circle. It is noted that, in FIG. 8A and FIG. 8B, the distance obtained by the range finder 12 approximately matches the position of the pedestrian.

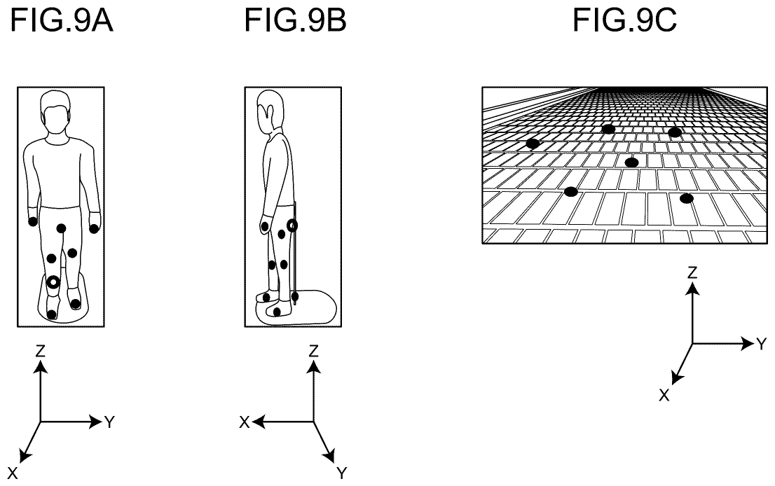

As illustrated in FIG. 9A and FIG. 9B, with respect to a transmission wave of the range finder 12, a reflection part of the object (for example, a pedestrian) has variations in the Z-axis direction, but the positions on the XY plane are dense to some extent. As illustrated in FIG. 8A and FIG. 8B, the dense positions on the XY plane correspond to the object and exist near the straight line OR. For this reason, a distance at which the object (for example, a pedestrian) is measured by the range finders 12 is likely to be dense in a specific region on the straight line OR, as indicated by the respective intersections of the straight line OR, the dashed-dotted circle, and the dotted circle in FIG. 8A.

On the other hand, as indicated by triangles depicted in FIG. 8B and filled circles depicted in FIG. 9C, a position of the reflection part of the road surface RD varies on the XY plane. Different positions on the XY plane do not exist near the straight line OR, unlike the object (for example, a pedestrian). For this reason, the distances of the road surface RD measured by the range finders 12 tend to vary on the straight line OR, as indicated by the respective intersections of the straight line OR, the dashed-dotted circle, and the dotted circle in FIG. 8B.

When FIG. 8A is compared with FIG. 8B, it is expected that the reflection intensity of the object and the reflection intensity of the road surface RD can be distinguished from each other from reflection intensities by focusing on a difference in dispersion between the object and the road surface RD, for example, the calculated dispersion of the fusion distance.

Therefore, the accumulation unit 34 lowers the threshold value for the reflection intensity and picks up the reflection intensity of the object and the reflection intensity of the road surface RD. The accumulation unit 34 accumulates the reflection intensity indicated by the signal of the range finder 12 in each of the coordinate regions set on the straight line OR.

In one example, as illustrated in FIG. 7, the accumulation unit 34 lowers the level of the threshold value from Sth1 to Sth2. The level of the threshold value Sth2 is a level that is slightly smaller than the average magnitude of the reflection intensity from the road surface RD. In the example illustrated in FIG. 7, reflection intensity is distributed in the coordinate region CR2, four reflection intensities are distributed in the coordinate region CR4, and two reflection intensities are distributed in the coordinate region CR6 as the reflection intensities exceeding the threshold value Sth2.

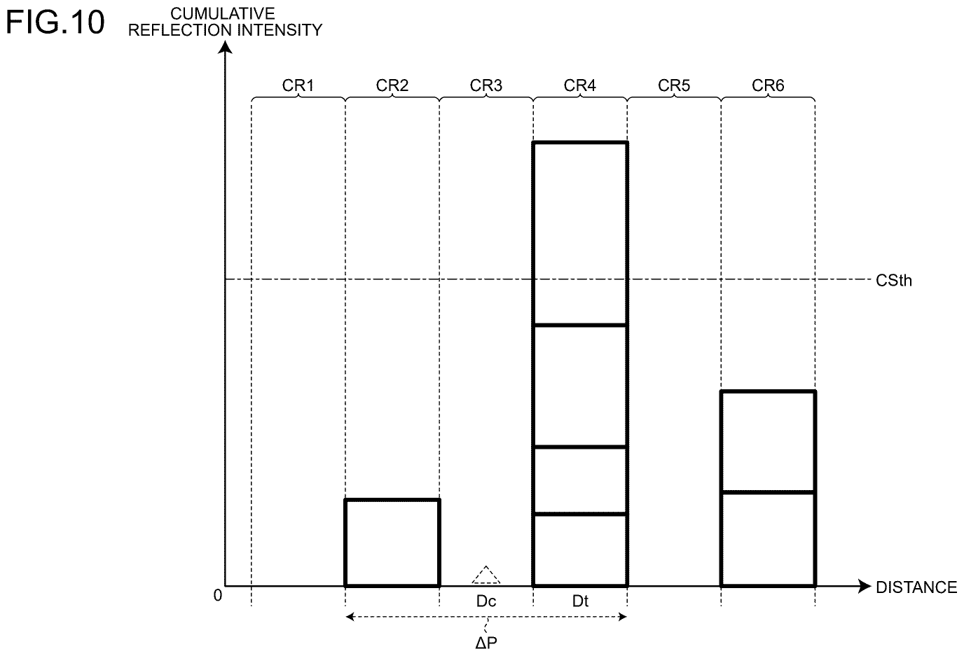

The accumulation unit 34 accumulates the reflection intensity exceeding the threshold value Sth2 out of the reflection intensities in each of the coordinate regions CR1 to CR6 on the straight line OR. In the case of FIG. 7, the accumulation unit 34 accumulates one reflection intensity in the coordinate region CR2, accumulates four reflection intensities in the coordinate region CR4, and accumulates two reflection intensities in the coordinate region CR6. As a result, the accumulation unit 34 can obtain an accumulation result as illustrated in FIG. 10. In FIG. 10, a distribution of a cumulative reflection intensity for each of the coordinate regions CR1 to CR6 is indicated by a histogram. In the above description, the coordinate regions CR1 to CR6 are set based on the distance Dc obtained from the imaging sensor 11, but the coordinate region CR may be set in units of the width W based on the fusion distance Df having the highest reflection intensity on the straight line OR.

The accumulation unit 34 supplies a result of the accumulation to the extraction unit 35.

The extraction unit 35 receives the accumulation result from the accumulation unit 34. The extraction unit 35 extracts the coordinate position of the object from the accumulation result of the accumulation unit 34. The extraction unit 35 extracts, as the coordinate position of the object, a coordinate position corresponding to a coordinate region where a cumulative value of the reflection intensities indicated by the signal of the range finder 12 exceeds the threshold value out of the coordinate regions set on the straight line OR. At this time, the extraction unit 35 may set a threshold value for a cumulative reflection intensity at a level corresponding to the object. Alternatively, the threshold value may be set to a threshold value exceeding a cumulative reflection intensity of an object such as a road surface which is a non-detection target. Thus, the extraction unit 35 can extract the coordinate position of the object by using a threshold value at a proper level corresponding to a detection target object.

In one example, the extraction unit 35 looks up information about the type of the object in the detection result obtained by the object detection unit 32, and determines a level corresponding to the type of the object. When the object is a pedestrian, the cumulative reflection intensity expected as a pedestrian is determined, and, as illustrated in FIG. 10, the level of a threshold value CSth for the cumulative reflection intensity is set at a level lower than the specified level and higher than the expected cumulative reflection intensity of the non-detection target object such as the road surface. The extraction unit 35 compares the cumulative reflection intensity of each of the coordinate regions CR1 to CR6 with the threshold value CSth. The extraction unit 35 can set, as the coordinate position of the object OB, a coordinate position corresponding to a distance Dt of the coordinate region CR4 where the cumulative reflection intensity exceeds the threshold value CSth out of the coordinate regions CR1 to CR6.

The extraction unit 35 may check the probability of the extracted coordinate position by determining whether the extracted coordinate position falls within a predetermined position range that covers a position estimated from the image of the imaging sensor 11. When the extracted coordinate position falls within the predetermined position range, the extraction unit 35 may output, to the determination unit 4, information representing that the extracted coordinate position is a “probable” coordinate position of the object. When the extracted coordinate position does not fall within the predetermined position range, the extraction unit 35 may discard the extracted coordinate position as a “non-probable”coordinate position of the object.

In one example, the extraction unit 35 sets, as the predetermined position range, a position range ΔP that covers a predetermined length in the plus and minus direction from a coordinate position corresponding to the distance Dc indicated by a dotted triangle in FIG. 10. In the example of FIG. 10, the position range ΔP is defined by a length of ±1.5×W from the dotted triangle (Dc), and the extracted coordinate position corresponding to the distance Dt falls within the position range ΔP. In this case, the extraction unit 35 outputs, to the determination unit 4, information representing that the extracted coordinate position is a probable coordinate position of the object OB.

In the above description, the distance Dc of the coordinate region CR is used. However, in order to increase the distance resolution, one of the fusion distances Df constituting the cumulative reflection intensity of the coordinate region CR may be selected and processed.

The detection processing unit 3 illustrated in FIG. 4 supplies a detection result to the determination unit 4. The detection result includes information about the presence or absence of an object and a coordinate position of the object.

For the determination unit 4, a position range with a high possibility of collision in the coordinate space on the road surface is set in advance as a collision determination range. Upon receiving the above-described detection result from the detection processing unit 3, the determination unit 4 determines whether the coordinate position of the object is within the collision determination range. The determination unit 4 supplies a determination result to the control unit 5.

The control unit 5 can execute driving assist processing in accordance with the determination result. When the coordinate position of the object falls outside the collision determination range, the control unit 5 generates information for calling attention and supplies the generated information to the notification unit 17. As a result, the notification unit 17 notifies a user of the information for calling attention.

If the coordinate position of the object falls within the collision determination range, the control unit 5 generates control information including a request for a braking operation and supplies the control information to the drive control unit 16. As a result, the drive control unit 16 operates the brake to stop the vehicle 1. At the same time, the control unit 5 generates warning information and supplies the warning information to the notification unit 17. Accordingly, the notification unit 17 notifies the user of the warning information.

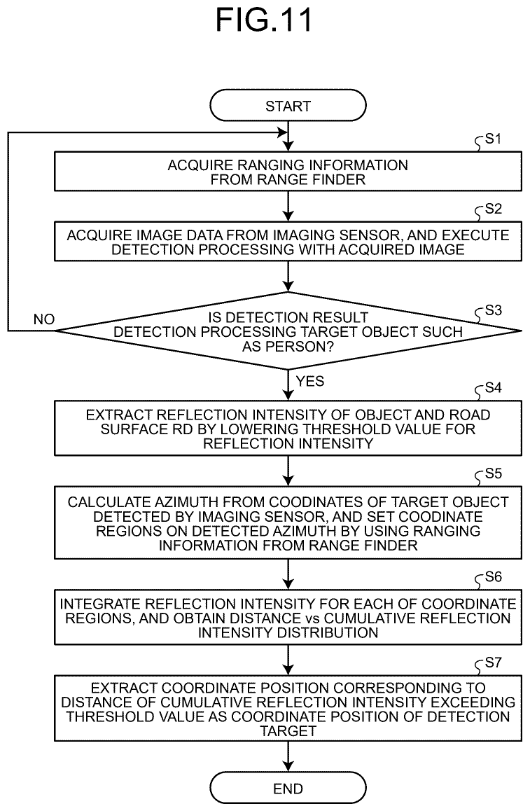

Next, the operation of the object detection device 2 will be described with reference to FIG. 11.

In the detection processing unit 3 of the object detection device 2, the distance calculation unit 31 acquires ranging information from the range finders 12_1 to 12_4 (S1). The distance calculation unit 31 extracts a reflection intensity and a distance from the received signal. The distance calculation unit 31 generates the ranging information in which the reflection intensity and the distance are correlated with each other. The distance calculation unit 31 supplies the ranging information to the estimation unit 33.

The object detection unit 32 acquires image data from the imaging sensor 11 and executes detection processing with the acquired image (S2). The object detection unit 32 detects an object included in the image by performing feature extraction on the image and performing comparison processing with feature values learned in advance on a feature extraction result. The object detection unit 32 may determine a pixel position of the object in the image. A detection result by the object detection unit 32 includes the pixel position of the object and a type of the object in the image. As described above, the type of the object includes a pedestrian, a bicycle, etc. The object detection unit 32 supplies the detection result to the estimation unit 33.

The estimation unit 33 determines whether the detection result of the object detection unit 32 indicates a detection processing target such as a person (S3). The estimation unit 33 may look up information about the type of the object included in the detection result and determine whether the detection result indicates the detection processing target on the basis of the information about the type of the object.

When the detection result does not indicate the detection processing target (No in S3), the estimation unit 33 returns the processing to S1. In this case, the reflection intensity is sufficiently large, so that the position estimation by the imaging sensor 11 may be omitted, and the position estimation by the range finders 12 may be performed.

When the detection result indicates the detection processing target (Yes in S3), the accumulation unit 34 lowers a threshold value for the reflection intensity and picks up the reflection intensity of the object and the reflection intensity of the road surface RD (S4). As illustrated in FIG. 7, the accumulation unit 34 lowers a level of the threshold value from Sth1 to Sth2. The level of the threshold value Sth2 is set to a level at which the reflection intensity of the detection target object including the reflection from the road surface RD exceeds the threshold value. In a case where the detection result of the estimation unit 33 indicates the detection processing target, the ranging may be performed again after lowering the threshold value of the range finder 12.

The estimation unit 33 estimates an azimuth θc of the object by using the image acquired by the imaging sensor 11. The estimation unit 33 extracts information about the pixel position of the object in the image from the detection result of the object detection unit 32. The estimation unit 33 regards the object distance Ds measured by the distance calculation unit 31 as a reflected distance from the object OB, and calculates a fusion distance Df on the azimuth θc of the object OB obtained from the image.

The accumulation unit 34 receives a calculated estimation result from the estimation unit 33. The accumulation unit 34 sets coordinate regions on the road surface RD according to a combination of the image acquired by the imaging sensor 11 and the distance Ds measured by the range finders 12_1 to 12_4 (S5). The accumulation unit 34 may set two or more coordinate regions on a straight line OR corresponding to the azimuth estimated by the estimation unit 33. The accumulation unit 34 may set each of the coordinate regions on a straight line with a width corresponding to the object.

The accumulation unit 34 integrates the reflection intensity in each of the coordinate regions and obtains a distance vs cumulative reflection intensity distribution (S6). The accumulation unit 34 accumulates the reflection intensity exceeding the threshold value Sth2 out of the reflection intensities in each of the coordinate regions CR1 to CR6 on the straight line OR. The accumulation unit 34 supplies an accumulation result to the extraction unit 35.

The extraction unit 35 extracts, as the coordinate position of the detection target, the coordinate position corresponding to the distance with the cumulative reflection intensity exceeding the threshold value (S7). The extraction unit 35 receives the accumulation result from the accumulation unit 34. The extraction unit 35 sets a threshold value for cumulative reflection intensity at a level corresponding to the object. The extraction unit 35 extracts, as the coordinate position of the object, a coordinate position corresponding to a coordinate region in which a cumulative value of the reflection intensity indicated by the signal of the range finder 12 exceeds the threshold value out of the coordinate regions set on the straight line OR.

It is noted that the extraction unit 35 may compare the extracted detection target with the detection coordinates of the imaging sensor 11 to determine whether the extracted detection target falls within a valid range.

The extraction unit 35 confirms the probability of the extracted coordinate position by determining whether the extracted coordinate position falls within a predetermined position range including a position estimated from the image of the imaging sensor 11. When the extracted coordinate position falls within the predetermined position range, the extraction unit 35 may output, to the determination unit 4, information indicating that the extracted coordinate position is a “probable” coordinate position of the object, and when the extracted coordinate position does not fall within the predetermined position range, the extraction unit 35 may discard the extracted coordinate position as a “non-probable” coordinate position of the object. It is noted that the extraction unit 35 may use the detection distance of the range finder 12 instead of the detection coordinates of the imaging sensor 11.

As described above, in the object detection device 2 of the embodiment, the signals of the range finder 12 are accumulated in each of the coordinate regions set on the road surface RD according to the combination of the image acquired by the imaging sensor 11 and the distance measured by the range finder 12, and the coordinate position of the object is extracted from the accumulation result. As a result, it is possible to detect an object having a relatively small reflection intensity and a road surface separately while lowering a threshold value of the range finder 12 and increasing sensitivity. Therefore, it is possible to expand a range of a detectable reflection intensity by a combination of the imaging sensor 11 and the range finder 12, and it is possible to improve accuracy of position detection even for a detection target object having a small reflection intensity.

It is noted that, in the object detection device of the above-described embodiment, the notation of the “unit” used for each component can be replaced with another notation such as “circuitry (or circuit)”, “assembly”, “device”, or “module”, as described above.

In addition, in the object detection device of the above-described embodiment, for example, the ECU 14 executes the program PG installed in the nonvolatile memory 19 to perform the object detection processing.

However, the program executed by the object detection device may be provided by being recorded as a file in an installable format or an executable format in a recording medium readable by the ECU 14 such as a CD-ROM, a flexible disk (FD), a CD-R, or a digital versatile disc (DVD). Alternatively, the program may be downloaded via a network and executed by the ECU 14.

In addition, at least part of the functions of the object detection device may be implemented by a dedicated hardware circuit not including a CPU.

As described above, the object detection device of the above-described embodiment can be implemented by software, hardware, or software in cooperation with hardware. The object detection device of the above-described embodiment may be implemented by a system, an apparatus, a method, an integrated circuit, a computer program, or a recording medium, or may be implemented by any combination of the system, the apparatus, the method, the integrated circuit, the computer program, and the recording medium. It is noted that a program product is a computer-readable medium in which a computer program is recorded.

In addition, each functional block of the object detection device of the above-described embodiment may be partially or entirely implemented as an LSI which is an integrated circuit, and each processing of the object detection device of the above-described embodiment may be partially or entirely controlled by one LSI or a combination of LSIs. The LSI may be configured by individual chips, or may be configured by one chip so as to include some or all the functional blocks. The LSI may include an input and an output of data. The LSI may be referred to as an IC, a system LSI, a super LSI, or an ultra LSI depending on a degree of integration.

However, a circuit integration method is not limited to the LSI, and may be implemented by a dedicated circuit, a general-purpose processor, or a dedicated processor. In addition, after manufacturing of the LSI, a field programmable gate array (FPGA) that can be programmed or a reconfigurable processor in which connections and settings of circuit cells inside the LSI can be reconfigured may be used. Each processing of the object detection device of the above-described embodiment may be implemented as digital processing or analog processing.

Further, when a circuit integration technology replacing the LSI appears by progress of a semiconductor technology or another derived technology, the functional blocks may be integrated by using the technology. Application of biotechnology and the like is possible.

While certain embodiments have been described, these embodiments have been presented by way of example only, and are not intended to limit the scope of the present disclosure. Indeed, the novel methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

What is claimed is:

1. An object detection device comprising:
an estimation circuit which, in operation, estimates a first position of an object multiple times by using a first distance to the object and an azimuth of the object, the first distance being measured by one or more range finders, the azimuth being estimated from an image of the object acquired by an imaging sensor;
an accumulation circuit which, in operation, accumulates the first positions of the object estimated the multiple times, the first positions being accumulated for each predetermined distance from the imaging sensor; and
an extraction circuit which, in operation, extracts a second position of the object from the accumulation result.

2. The object detection device according to claim 1, further comprising an object detection circuit which, in operation, detects a type of the object by using the image, wherein
the one or more range finders are plural, and
the estimation circuit is which, in operation,, when the type of the object does not correspond to a predetermined object, extracts the second position of the object by using second distances measured by the plural range finders.

3. The object detection device according to claim 1, further comprising an object detection circuit which, in operation, detects a type of the object by using the image, wherein
the predetermined distance from the imaging sensor is set by an interval corresponding to the type of the object.

4. The object detection device according to claim 1, wherein the extraction circuit is which, in operation, extracts the second position of the object when a cumulative value of the first position of the object exceeds a threshold value.

5. The object detection device according to claim 1, wherein
the estimation circuit is which, in operation, further estimates a fourth position of the object by using the image, and
the extraction circuit is which, in operation, extracts, as the second position of the object, a position falling within a predetermined range including the fourth position in the accumulation result.

6. An object detection method comprising:
estimating a first position of an object multiple times by using a first distance to the object and an azimuth of the object, the first distance being measured by one or more range finders, the azimuth being estimated from an image of the object acquired by an imaging sensor;
accumulating the first positions of the object estimated the multiple times, the first positions being accumulated for each predetermined distance from the imaging sensor; and
extracting a second position of the object from the accumulation result.

7. The object detection method according to claim 6, further comprising detecting a type of the object by using the image, wherein,
when the type of the object does not correspond to a predetermined object, the extracting of the second position is performed by using second distances measured by the plural range finders.

8. The object detection method according to claim 6, further comprising detecting a type of the object by using the image, wherein
the predetermined distance from the imaging sensor is set by an interval corresponding to the type of the object.

9. The object detection method according to claim 6, wherein the extracting of the second position is performed when a cumulative value of the first position of the object exceeds a threshold value.

10. The object detection method according to claim 6, further comprising estimating a fourth position of the object by using the image, wherein
the extracting of the second position is performed by extracting, as the second position of the object, a position falling within a predetermined range including the fourth position in the accumulation result.
